(19) United States
(12) Patent Application Publication
(10) Pub. No.: US 2007/0279818 A1
(43) Pub. Date: Dec. 6, 2007

(54) Load abnormality detection circuit

(75) Inventor: Koji Tanigawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/633,471

(22) Filed: Dec. 5, 2006

(30) Foreign Application Priority Data
Jun. 6, 2006 (JP) 2006-157085

(51) Int. Cl. H02H 3/24

(52) U.S. Cl. 361/90

(57) ABSTRACT

A load abnormality detection circuit serves to stop the operation of a load when the load is shorted to a VB power supply, or when the load is layer shorted, whereby heat damage of a load control transistor is prevented. A microcomputer provides a drive signal to a base of the transistor thereby to drive the load. A voltage detection circuit detects a voltage level between a collector and an emitter of the transistor and inputs it to the microcomputer. The microcomputer sets first and second thresholds corresponding to the voltage levels of a collector voltage of the transistor when the load is abnormal, and detects when the load is abnormal based on a comparison of the voltage level detected with the thresholds. The presence or absence of abnormality of the load is detected based on at least two comparison results.

### BACKGROUND OF THE INVENTION

1. Field of the Invention

The present invention relates to a load abnormality detection circuit for a system that has a battery power supply (hereinafter referred to as a “VB power supply”) and a transistor to drive a load, and in particular, it relates to a load abnormality detection circuit with a protective function to prevent an overcurrent from flowing through the transistor when a load line connected to the system is shorted to the VB power supply or when the load is layer shorted (i.e., shorted between layers).

2. Description of the Related Art

In general, a control unit for a system having a transistor for driving a load includes a microcomputer (hereinafter also referred to as a “micon”) and a transistor, which has a base connected to a drive signal output port of the microcomputer, an emitter earthed to the ground, and a collector connected to an output terminal of the control unit. In addition, the output terminal of the control unit is connected to a terminal of the load, which is in turn connected to a VB power supply.

In such a kind of system, the turn on/off of the load is controlled by the voltage level of a drive signal output from the drive signal output port of the microcomputer. That is, when the drive signal output port is at a high (H) level, the transistor is turned on so that a current supplied from the VB power supply to the transistor through the load and the drive signal output terminal flows from the collector to the emitter of the transistor.

On the other hand, when the drive signal output port is at a low (L) level, the base and the emitter of the transistor become the same potential, so the transistor is turned off. As a result, current does not flow from the VB power supply to the load, and hence the load is turned off.

In order to detect an abnormality in the load by monitoring, by means of the microcomputer, the voltage level of a collector part of the transistor that varies in this manner according to the turn on/off of the drive signal, there has conventionally been used a voltage detection circuit that detects the voltage level of the collector part of the transistor (see, for example, a first patent document: Japanese patent application laid-open No. 2005-248923).

In the conventional load abnormality detection circuit, the voltage level of the collector part of the transistor is merely detected, so there is the following problem. That is, when the load line including the terminal of the load and the output terminal of the control unit is shorted to the VB power supply, or when the load is layer shorted, the operation of the load can not be stopped, so there is a possibility that an excessively large current flows from the VB power supply to the transistor, whereby the transistor might be heat damaged.

### SUMMARY OF THE INVENTION

Accordingly, the present invention is intended to solve the problem as referred to above, and has for its object to obtain a load abnormality detection circuit which can detect an abnormality of a load in a reliable manner based on the result of the comparison of voltage levels detected at least two timings during driving of the load with thresholds set by a program in a microcomputer even when a load line including a terminal of the load and an output terminal of a control unit is shorted to a VB power supply, or when the load is layer shorted.

Another object of the present invention is to obtain a load abnormality detection circuit which can achieve a protective function to prevent an overcurrent from flowing into a load in a reliable manner by stopping the operation of the load upon detection of an abnormality thereof to interrupt current from a VB power supply.

Bearing the above objects in mind, a load abnormality detection circuit according to the present invention includes a control unit that drives a load connected to a VB power supply and detects an abnormality of the load. The control unit includes: a low side transistor having an emitter, a base, and a collector connected to the load; a microcomputer that provides a drive signal to the base of the transistor thereby to drive the load; and a voltage detection circuit that detects a voltage level between the collector and the emitter of the transistor and inputs the voltage level thus detected to the microcomputer. The microcomputer includes: a threshold setting section that sets a first and a second threshold corresponding to voltage levels of the load which is abnormal; and an abnormality detection section that detects when the load is abnormal based on a comparison between the voltage level input thereto from the voltage detection circuit and the thresholds. The abnormality detection section detects the presence or absence of abnormality of the load based on at least two comparison results including the result of a first comparison between a first voltage level detected immediately after the load is driven and the first threshold, and the result of a second comparison between a second voltage level detected when the load has been driven for a fixed time and the second threshold.

According to the present invention, when a VB power supply short or layer short of the load is detected, the microcomputer stops the operation of the load whereby the transistor for controlling the operation of the load can be prevented from being heat damaged.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a circuit block diagram showing a load abnormality detection circuit according to a first embodiment of the present invention.

FIG. 2 is a timing chart illustrating the behaviors of voltage levels detected according to the first embodiment of the present invention.

FIG. 3 is a timing chart illustrating the relation between the voltage levels detected and thresholds according to the first embodiment of the present invention.

### DESCRIPTION OF THE PREFERRED EMBODIMENT

Hereinafter, a preferred embodiment of the present invention will be described in detail while referring to the accompanying drawings.

### Embodiment 1

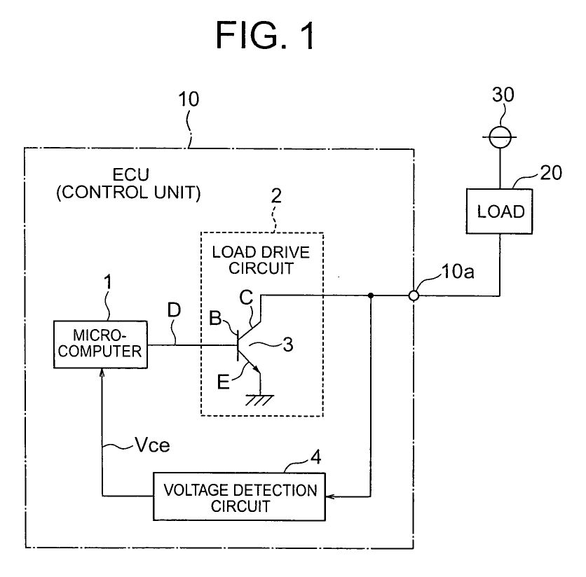

Referring to the drawings and first to FIG. 1, there is shown a circuit block diagram of a load abnormality detection circuit according to a first embodiment of the present invention, in which a system including an ECU (electronic control unit) 10 for driving a load 20 connected to a VB power supply 30 is schematically illustrated.

In FIG. 1, the ECU 10, which constitutes a control unit, is provided with a microcomputer 1, a load drive circuit 2 comprising a transistor 3, and a voltage detection circuit 4, and serves to drive the load 20 through an output terminal 10a and detect an abnormality of the load 20.

The transistor 3 comprises a low side transistor, of which a collector C is connected to the load 20. The microcomputer 1 has an output port connected to a base B of the transistor 3 for providing a drive signal D to the base B of the transistor 3 thereby to drive the load 20. The transistor 3 also has an emitter E earthed to the ground, with its collector C being connected to the output terminal 10a of the ECU 10. The output terminal 10a of the ECU 10 is connected to one end of the load 20, which is in turn connected at the other end thereof to the VB power supply 30 in the form of a battery.

In this system, the turn on/off of the load 20 is controlled by the voltage level of the drive signal D output from the microcomputer 1. Specifically, when the drive signal D is at a high (H) level, the transistor 3 is turned on so that a current supplied from the VB power supply 30 to the transistor 3 through the load 20 and the output terminal 10a flows from the collector C to the emitter E of the transistor 3.

On the other hand, when the drive signal D is at a low (L) level, the base B and the emitter E of the transistor 3 become the same potential, so the transistor 3 is turned off. As a result, no current flows from the VB power supply 30 to the load 20, and hence the load 20 is turned off.

At this time, the voltage detection circuit 4 monitors the voltage level Vce of a collector part (i.e., a collector voltage between the collector and the emitter) of the transistor 3 that varies in accordance with the turn on/off of the drive signal D, and inputs it to the microcomputer 1.

The microcomputer 1 includes a threshold setting section that sets thresholds Th1, Th2 corresponding to the voltage levels of the collector voltage of the transistor 3 at the time when the load 20 is abnormal, and an abnormality detection section that detects when the load 20 is abnormal, based on the comparison of the voltage level Vce input from the voltage detection circuit 4 with the thresholds Th1, Th2.

The abnormality detection section detects the presence or absence of abnormality of the load 20 by focusing attention on the voltage level Vce between the collector and the emitter of the transistor 3 during driving of the load 20. That is, as will be described later, the abnormality detection section in the microcomputer 1 detects the presence or absence of abnormality of the load 20 based on at least two comparison results including the result of a first comparison between a first voltage level Vce1 detected immediately after driving of the load 20 (at time point t1) and the threshold Th1 and the result of a second comparison between a second voltage level Vce2 detected when the load 20 has been driven for a fixed time τ (at time point t2) and the threshold Th2.

In addition, the microcomputer 1 includes an abnormal stop section that serves to stop the operation of the load 20 when an abnormality of the load 20 is detected by the abnormality detection section.

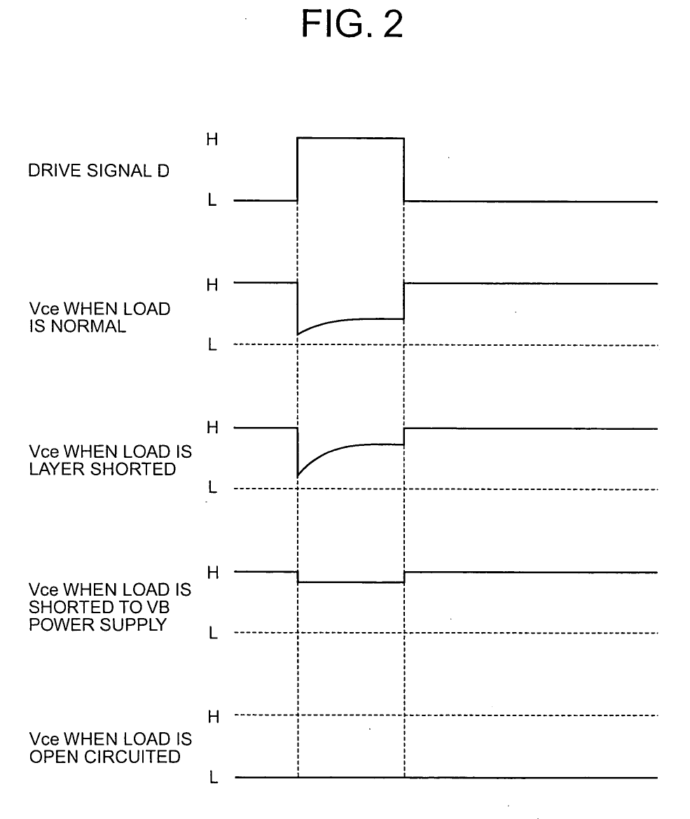

FIG. 2 is a timing chart of the voltage level Vce monitored by the microcomputer 1, in which the behavior of the voltage level Vce that varies in response to the drive signal D is shown in case where the load 20 is normal, and in case where the load 20 is abnormal in comparison with each other.

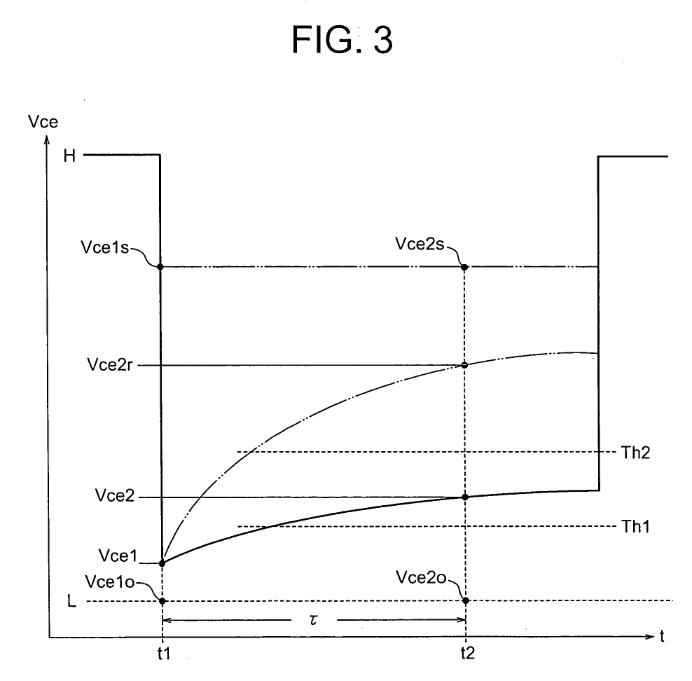

FIG. 3 is a timing chart that shows the differences of the individual voltage levels in FIG. 2. In FIG. 3, a solid line waveform indicates a voltage level when the load 20 is normal, whereas a broken line, an alternate long and two short dashes line, and an alternate long and short dash line indicate individual voltage levels when an open circuit abnormality of the load 20 is generated, when a short circuit abnormality of the load 20 shorted to the VB power supply 30, and when a layer short circuit abnormality of the load 20 is generated, respectively.

In this case, as timings at which the voltage level Vce is detected (monitored) by the voltage detection circuit 4, there are set two time points including a time point t1 immediately after the load 20 is driven, and a time point t2 at which the load 20 has been driven for the fixed time τ. Here, note that when the load 20 is normal (see the solid line), the relation between a voltage level Vce1 detected at time point t1 and a voltage level Vce2 detected at time point t2 becomes Vce1<Vce2, whereas when a layer short circuit occurs (see the alternate long and short dash line), the relation between the voltage level Vce1 detected at time point t1 and a voltage level Vce2r detected at time point t2 becomes Vce1<Vce2r. However, as is clear from FIG. 3, the relation between the voltage level Vce2 when the load 20 is normal and the voltage level Vce2r when a layer short circuit occurs is Vce2<Vce2r.

On the other hand, when the load 20 is open circuited (see the broken line), the relation between a voltage level Vce1o detected at time point t1 and a voltage level Vce2o detected at time point t2 becomes Vce1o=Vce2o=0 (i.e., a low “L” level).

In addition, when a short circuit to the VB power supply 30 occurs (see the alternate long and two short dashes line), the relation between a voltage level Vce1s detected at time point t1 and a voltage level Vce2s detected at time point t2 becomes Vce1s=Vce2s. However, as is clear from FIG. 3, the relation between the voltage level Vce1o (=Vce2o=0) when the load 20 is open circuited and the voltage level Vce1s (=Vce2s) when a short circuit to the VB power supply occurs becomes Vce1o<Vce1s, and Vce2r<Vce1s.

Accordingly, in order to determine the individual abnormal states, the thresholds Th1, Th2 (Th1<Th2), which are different in level, as indicated by dotted lines, are set by the threshold setting section in the microcomputer 1. In this case, the threshold Th1 is set so as to satisfy the relation of Vce1<Th1<Vce2, as is clear from FIG. 3, and the threshold Th2 is set so as to satisfy the relation of Vce2<Th2<Vce2r.

Hereinafter, reference will be made to the behavior of the voltage level Vce and an abnormality detection operation upon occurrence of an abnormality in the first embodiment of the present invention in individual cases when the load 20 is normal, open circuited, shorted to the VB power supply, and layer shorted, respectively.

First of all, as shown in FIG. 3, the microcomputer 1 sets the thresholds Th1, Th2 by means of the threshold setting section, and the voltage detection circuit 4 decides the timings or time points t1, t2 at which the voltage level Vce is detected and input to the microcomputer 1 for monitoring. At this time, if the load 20 is normal, the transistor 3 is turned on at the timing when the drive signal D becomes an H level, whereby a current supplied from the VB power supply 30 to the transistor 3 through the load 20 flows from the collector C to the emitter E of the transistor 3. As a result, an overcurrent does not flow to the transistor 3, and the heat generation of the transistor 3 is limited, so there is no possibility that the transistor 3 is heat damaged. In this case, the voltage level detected at time point t1 immediately after the driving of the load 20 becomes Vce1 (>0), and the voltage level at time point t2 after the load 20 has been driven for the fixed time τ becomes Vce2 (>Vce1).

On the other hand, when an open circuit abnormality occurs in the load 20, the voltage levels Vce1o, Vce2o detected at time points t1, t2 always become “0” (L level) even if the drive signal D is at the H or L level.

In addition, in case where there occurs a VB power supply short circuit abnormality in the load 20 (i.e., the load 20 is short circuited to the VB power supply 30), the transistor 3 is turned off if the drive signal D is at the L level. As a result, no current flows from the VB power supply 30, and hence the transistor 3 does not generate heat.

However, in case where there occurs a VB power supply short circuit abnormality in the load 20, the transistor 3 is turned on if the drive signal D is at the H level, so that a current from the VB power supply 30 flows directly from the collector C to the emitter E of the transistor 3, and hence an excessively large current flows through the transistor 3. As a result, the voltage level Vce detected by the voltage detection circuit 4 becomes Vce1s (=Vce2s>Vce2r). At this time, the microcomputer 1 monitors the voltage levels Vce1s, Vce2s at time points t1, t2 by using the voltage detection circuit 4.

Also, in the microcomputer 1, the threshold setting section sets through a program the threshold Th1, and the abnormality detection section detects the presence or absence of abnormality of the load 20 based on a comparison between the voltage level Vce and the threshold Th1.

Further, when it is detected that the voltage level Vce1s (=Vce2s) exceeds the threshold Th1 during driving of the load 20 (i.e., an abnormality occurrence state), the abnormal stop section in the microcomputer 1 stops the operation of the load 20.

Here, the setting condition of the threshold Th1 is defined, as shown in the following expression (1).

Vce1<Th1<Vce1s (=Vce2s) (1)

Here, note that when there occurs a VB power supply short circuit in the load 20, the presence or absence of abnormality of the load 20 can be determined at time point t1 immediately after the driving of the load 20, so either of the time points t1, t2 may be selected as the timing at which the voltage level Vce is monitored.

In addition, in case where there occurs a layer short circuit abnormality in the load 20, the transistor 3 is turned off if the drive signal D is at the L level. As a result, no current flows from the VB power supply 30, and hence the transistor 3 does not generate heat.

Subsequently, the drive signal D becomes the H level during the layer short circuit abnormality, and immediately after the load 20 is driven (time point t1), the voltage level Vce monitored through the voltage detection circuit 4 is the same voltage level Vce1 as that when the load 20 is normal, so the presence or absence of abnormality can not be determined.

However, at time point t2 after the load 20 has been driven for only the fixed time τ, an excessive current, being larger than the current when the load 20 is normal, flows so the voltage level Vce of the collector part of the transistor 3 becomes Vce2r. Accordingly, at the time of the layer short circuit of the load 20, the microcomputer 1 monitors the voltage level Vce2r at time point t2 through the voltage detection circuit 4.

At this time, in the microcomputer 1, the threshold setting section sets through a program the threshold Th2, and the abnormality detection section detects the presence or absence of abnormality of the load 20 based on a comparison between the voltage level Vce and the threshold Th2.

Further, when it is detected that the voltage level Vce2r exceeds the threshold Th2 at time point t2 during driving of the load 20 (i.e., an abnormality occurrence state), the abnormal stop section in the microcomputer 1 stops the operation of the load 20.

Here, the setting condition of the threshold Th2 is defined in association with the above-mentioned threshold Th1, as shown in the following expression (2).

Vce1<Th1<Vce2<Th2<Vce2r<Vce2s (2)

Here, note that when the load 20 is layer shorted, the time point t2 is selected as the timing at which the voltage level Vce is monitored.

As described above, according to the first embodiment of the present invention, when abnormality due to a VB power supply short circuit or a layer short circuit occurs in the load 20, the operation of the load 20 is stopped by detecting an abnormality occurrence state in a reliable manner, so that it is possible to prevent the thermal damage of the transistor 3.

In addition, by inputting information on the load 20 to the microcomputer 1, it is possible to set, through a program, the thresholds Th1, Th2 in the form of comparison references for abnormality detection to optimal values in accordance with the load 20 connected to the ECU 10.

Moreover, by inputting the output voltage of the VB power supply 30 to the microcomputer 1, the thresholds Th1, Th2 can be set in accordance with the voltage value of the VB power supply 30.

Further, in case where there occurs a VB power supply short circuit abnormality in the load 20 (see the alternate long and two short dashes line in FIG. 3), it is possible to detect the abnormality occurrence state at time point t1 immediately after the load 20 is driven. Thus, the transistor 3 for driving the load 20 can be protected by quickly stopping the driving of the load 20.

Furthermore, according to the first embodiment of the present invention, the state of the load 20 can be separately detected in individual cases when the load 20 is normal, open circuited, shorted to the VB power supply, and layer shorted, respectively. As a result, the individual states of the load 20 can be analyzed in the microcomputer 1 and displayed or saved as a diagnosis function.

While the invention has been described in terms of a preferred embodiment, those skilled in the art will recognize that the invention can be practiced with modifications within the spirit and scope of the appended claims.

What is claimed is:

1. A load abnormality detection circuit including a control unit that drives a load connected to a VB power supply and detects an abnormality of said load,
said control unit comprising:
a low side transistor having an emitter, a base, and a collector connected to said load;
a microcomputer that provides a drive signal to the base of said transistor thereby to drive said load; and
a voltage detection circuit that detects a voltage level between the collector and the emitter of said transistor and inputs the voltage level thus detected to said microcomputer;
said microcomputer comprising:
a threshold setting section that sets a first and a second threshold corresponding to voltage levels of said load which is abnormal; and
an abnormality detection section that detects when said load is abnormal based on a comparison between said voltage level input thereto from said voltage detection circuit and said thresholds;
wherein said abnormality detection section detects the presence or absence of abnormality of said load based on at least two comparison results including the result of a first comparison between a first voltage level detected immediately after said load is driven and said first threshold, and the result of a second comparison between a second voltage level detected when said load has been driven for a fixed time and said second threshold.

2. The load abnormality detection circuit as set forth in claim 1, wherein said microcomputer includes an abnormal stop section that serves to stop the operation of said load when an abnormality of the load is detected by said abnormality detection section.
